(19) United States
(12) Patent Application Publication
(10) Pub. No.: US 2024/0402653 A1
(43) Pub. Date: Dec. 5, 2024

(54) WATCH COMPONENT AND ITS MANUFACTURING METHOD

(71) Applicant: ROLEX SA, Genève 26 (CH)

(72) Inventors: Carine BIENVENU, PRINGY (FR); Grégoire FLURI, LANCY (CH); Jean-Baptiste ROBIN, ANNEMASSE (FR)

(21) Appl. No.: 18/735,116

(22) Filed: Jun. 5, 2024

(30) Foreign Application Priority Data
Jun. 5, 2023 (EP) 23177386.2

(51) Int. Cl. G04D 3/00; G04B 19/18

(52) U.S. Cl. CPC G04D 3/0069; G04B 19/18; G04D 3/0092

(57) ABSTRACT

The invention relates to a method of manufacturing of a watch component, comprising the steps consisting in:
(10) forming a blank (200E1), particularly by injection, including at least one base surface (210) and at least one projecting portion (220) projecting from the base surface (210),
(20) forming at least one coating layer (250) covering at least a part of the base surface (210) and/or over at least a part of the projecting portion (220),
(30) removing by laser ablation at least a part of said at least one coating layer (250).
(40) texturing by laser processing at least a part of the base surface (210) and/or at least a part of the projecting portion (220), and/or at least a part of the at least one coating layer (250).

### CROSS-REFERENCE TO RELATED APPLICATIONS

The present application claims priority to European Application No. 23177386.2 filed with the European Patent Office on Jun. 5, 2023 and entitled “WATCH COMPONENT AND ITS MANUFACTURING METHOD,” which is incorporated herein by reference in its entirety for all purposes.

### TECHNICAL FIELD OF THE INVENTION

This invention generally relates to the manufacturing of watch components, and in particular, this invention may relate to the manufacturing of watch components having relief parts, and parts covered by a coating.

### PRIOR ART

In the prior art of watch components with relief parts, the document EP 3 892 151 A1 is known, disclosing a watch component with parts covered by a coating, and which may comprise decorative inserts in relief. On the other hand, this document does not propose any solutions for texturing certain parts of the component, nor does it suggest any component with relief parts having a specific appearance by comparison with a base part of the component. Such watch components (coated, with relief parts) are often used as visible parts of a timepiece and must therefore be implemented precisely and reliably to ensure the most beautiful appearance for the user, in a durable way. The document WO2018109065A1 relates to a method of manufacturing of a decorative element or a watch dial made of non-conductive material, in which a base made of non-conductive materials is covered by a sacrificial layer of resin, etched, then mechanically planed, and finally the sacrificial layer of resin is dissolved by chemicals.

### SUMMARY OF THE INVENTION

One aim of this invention is to improve the prior art mentioned above and in particular, firstly, to propose a method of manufacturing a watch component that allows to efficiently, quickly, precisely and robustly manufacture a watch component which features relief parts, and parts of different colors and/or of different textures, to offer the user a beautiful appearance that will last over time. One aim of this invention is also to propose a watch component having projecting or relief parts, and parts of different colors and/or of different textures, to offer the user a watch component with a beautiful appearance that will last over time, and also pleasant haptic sensations allowing a multi-sensory reading of the patterns.

To do so, a first aspect of the invention relates to a method of manufacturing of a watch component, comprising the steps consisting in:
forming a blank, particularly by injection, including or comprising at least one base surface and at least one projecting portion projecting from to the base surface,
forming at least one coating layer covering at least a part of the base surface and/or covering at least a part of the at least one projecting portion,
removing by laser ablation at least a part of said at least one coating layer,
texturing by laser processing at least a part of the base surface previously covered by said at least one coating layer and/or at least a part of the at least one projecting portion previously covered by said at least one coating layer, and/or at least a part of the at least one coating layer.

The method according to the implementation above comprises a step consisting in covering the base surface and the at least one projecting portion by a coating, and then comprises a step consisting in removing the coating or at least one coating layer and in texturing the visible surface of the component. One can thus propose a watch component, with projecting or relief parts, parts covered by a coating, and textured parts, which has a beautiful appearance and/or a very high precision of execution, since the delimiting of the coating and/or texturing have been done by laser processing. One can also propose blank materials and/or coating that are resistant to environmental stresses or impacts, with high wear resistance, and/or high hardness, the laser processing being easily able to remove the coating or at least one coating layer and/or texture the blank material. It can be noted that it is possible to form at least one coating layer covering at least a part of the base surface and/or at least a part of the at least one projecting portion, i.e. one can form a single coating layer, but one can also form two, three or even more coating layers. Provision can be made for certain coating layers to cover all the parts of the blank, or all the parts that will be visible to the user. Provision can also be made for certain coating layers to partially cover the blank, or partially cover the parts that will be visible to the user.

The manufacturing method and/or the watch component can moreover have one or more of the following features, taken alone or in combination.

According to an embodiment, the step of removal by laser ablation and the step of texturing by laser processing are at least partially simultaneous, and/or carried out with the same laser source. In particular, on the parts where the entire coating is removed, provision can be made for a texture to be formed on the previously coated material during the same pass of the laser beam, or during the same passes of the laser beam over the watch component as those intended to remove the coating. In other words, the step of removal and the step of texturing are simultaneous, carried out during the same irradiation operation, during the same pass of the laser beam. A very high degree of precision is then obtained, since the border of a coated area corresponds to the border of a textured area: there is no shift or “neither-coated-nor-textured” area between a coated area and a textured area. In other words, the laser ablation of the coating carries out the texturing at the same time, and this makes it possible to go directly from a coated surface to a bared and textured surface. In other words, the step of removal by laser ablation and the step of texturing by laser processing are at least partially simultaneous, i.e. they are done at the same time, and/or the irradiation of the part by the laser beam (i.e. the pass of one single laser beam) leads at once to the removal of said at least one coating layer and to the texturing of at least a part of the base surface (previously covered by said at least one coating layer) and/or at least a part of the at least one projecting portion (previously covered by said at least one coating layer), and/or at least a part of the at least one coating layer.

According to an embodiment, the step of removal by laser ablation is carried out to:
locally remove a total thickness of the coating and optionally a thickness of the blank from the base surface and/or
locally remove a thickness of the coating less or lower than the total thickness of the coating and/or
locally remove a variable thickness of the coating strictly less or lower than the total thickness of the coating. The ablation and/or texturing processing done with the laser source allows for a wide variety of removals and/or texturings, on the same component: at certain places, provision can be made for removing the entire coating, and optionally for texturing the blank material, and in other places, provision can be made for removing a part of the coating, namely only certain coating layers, and at still other places, provision can be made for removing a variable part of the coating, and finally at yet other places, provision can be made for texturing the coating.

Preferably, the removal step is simultaneous and/or done with the same laser source as that used in the texturing step. According to a particular embodiment, these two steps are carried out on a coating covering at least a part of the base surface, at least a part of the surface forming the top of the at least one projecting portion and at least a part of the surface forming the side of the at least one projecting portion, and have the aim of removing the coating covering at least a part of the base surface, as well as texturing at least a part of the base surface. According to this implementation, the at least one projecting portion is coated (preferably entirely coated) by said at least one coating layer, the base surface of the blank being devoid of any coating (preferably entirely devoid of any coating), and the base surface of the blank being textured (preferably entirely textured). According to this implementation, there is no area of transition or offset between the coated and textured areas, since at the level of the base surface that was initially coated, it is the same laser processing operation that has carried out the removal and the texturing of the material: a stripped area of the coating is simultaneously textured.

According to an embodiment, the step of removal by laser ablation and/or the step of texturing by laser processing is carried out on a side of the projection part. In particular, the step of removal by laser ablation and/or the step of texturing by laser processing can be carried out on a side of the projecting part, this latter forming a relief angle (an angle of clearance) to a normal of the base surface preferably between 5° and 25°, in particular between 10° and 20°.

According to an embodiment, the laser texturing of the sides can be different from the laser texturing of the base surface and/or the top surface of the projecting portion. In other words, the coating layer and the blank body material of the sides, of the base surface and/or of the top surface of the projecting portion are each textured differently, specifically or separately.

According to an embodiment, said at least one projecting portion forms a closed pattern, such as for example a “O” (letter O) or a “0” (zero), or any other closed pattern or decoration. The term “closed pattern” should be understood to mean any pattern comprising a closed pattern portion, such as for example a “4” or a “9”. According to an embodiment, the closed pattern comprises or has an inner surface, arranged for example at the same level or aligned with said at least one base surface. According to an embodiment, the coating layer is formed on the inner surface. According to an embodiment, the coating layer formed on the inner surface is at least partially removed by the laser ablation and/or at least partially textured by laser processing. Preferably, the inner surface is at least partially textured during the at least partial removal of the coating layer formed on said inner surface. Thus, the step consisting in at least partially ablating the coating layer formed on the inner surface and the step consisting in texturing said inner surface can be done simultaneously.

According to an embodiment, said at least one projecting portion forms or has at least two reliefs spaced apart by less than 5 mm, less than 3 mm, or less than 2 mm.

According to an embodiment, the step of removal by laser ablation and/or the step of texturing by laser processing are carried out with an ultrashort pulsed laser source, and preferably with a pulsed laser source arranged to emit pulses in the order or in the range of the nanosecond, and more preferably in the order or in the range of the picosecond, and more preferably still in the order or in the range of the femtosecond. Such a laser source makes it possible to carry out processing with high precision and/or without thermally affecting the rest of the part. Provision can typically be made for imposing a relative motion between the watch component and the laser source, by means of movable tables and/or movable mirrors.

According to an embodiment, the manufacturing method may comprise a step of machining and/or grinding of the blank, executed after the step of formation of the blank and in particular between the step of formation of the blank and the step of formation of said at least one coating layer. Provision can typically be made for machining/grinding all or part of the functional surfaces of the watch component before making the coating, but provision can be made for machining/grinding surfaces of the watch component at other times.

According to an embodiment, the manufacturing method may comprise a step of termination or finishing of the blank executed after the step of formation of the blank, and in particular between the step of formation of the blank and the step of formation of said at least one coating layer. A finishing step can typically cause a modification of the surface condition, in particular the roughness, and/or a modification of the appearance of the surface such as the brilliance. Provision can typically be made for making a finishing on all or part of the visible surfaces of the watch component before forming the at least one coating layer, but provision can be made for making a finishing on surfaces of the watch component at other times.

According to an embodiment, the step of formation of the at least one coating layer comprises a step of Physical Vapor Deposition (PVD), and/or a step of Chemical Vapor Deposition (CVD), and/or a step of Atomic Layer Deposition (ALD). Such methods make it possible to form very hard layers of coating (for example of a hardness greater than 500 HV, preferably greater than 1000 HV, or preferably greater than 1500 HV), and/or with specific colors or at least colors different from the color of the base material of the blank. In other words, the at least one coating layer is a decorative layer, the remaining parts of which are intended to form an external surface of the watch component (exposed to friction, impacts, humidity etc.)

According to an embodiment, the step of formation of the blank is carried out to form a blank comprising a ceramic material and/or a metallic material and/or a cermet. A cermet is typically a material with a ceramic skeleton, within which a metallic phase exists.

According to an embodiment, the step of formation of at least one coating layer comprises the formation of at least one layer of ceramic material and/or at least one layer of material comprising a metallic composite.

According to an embodiment, the step of formation of at least one coating layer comprises the formation of at least one layer comprising at least:
a metal carbide, in particular tungsten carbide, and/or titanium carbide, and/or zirconium carbide, and/or tantalum carbide, and/or niobium carbide, and/or chromium carbide, and/or hafnium carbide, and/or
at least one metal nitride, in particular chromium nitride, and/or boron nitride, and/or zirconium nitride, and/or titanium nitride, and/or tantalum nitride, and/or niobium nitride, and/or hafnium nitride, and/or
a combination of different metal carbides as above and/or a combination of different metal nitrides as above, and/or a combination of a metal nitride as above and a metal carbide as above in an alloy.

According to an embodiment, the metal of the coating layer is part of the group comprising tungsten (W), and/or titanium (Ti), and/or zirconium (Zr), and/or tantalum (Ta), and/or niobium (Nb), and/or chromium (Cr), and/or hafnium (Hf), and/or gold (Au), and/or palladium (Pd), and/or platinum (Pt), or their alloys such as titanium-aluminum (TiAl), chromium-aluminum (CrAl), or hafnium-titanium (HfTi) alloys.

According to an embodiment, the texturing step is provided to texture the at least one coating layer and/or the base surface and/or the projecting portion, forming a satin finishing, and/or a brushing, and/or a snailing, and/or a sunray brushing, and/or at least one “côthe de Genève”, and/or circular graining and/or spotting and/or any type of decoration, in particular any type of decoration with repeated patterns.

According to an embodiment, said at least one base surface is a bevelled or curved or convex surface. In particular, said at least one base surface may be non-flat. According to an embodiment, said at least one projecting portion has a bevelled or curved or convex surface. In particular, said at least one upper surface may be non-flat.

A second aspect of the invention can be related to a method of manufacturing of a timepiece, comprising the steps consists in:
providing a watch component manufactured according to the manufacturing method according to the first aspect of the invention,
assembling the watch component in the timepiece, so as to position in a visible part of the timepiece at least a part of the watch component in which:
said at least one coating layer has been at least partly removed and/or textured, and/or
the base surface and/or the at least one projecting portion has been textured.

A third aspect of the invention may relate to a watch component intended to be mounted in a timepiece, comprising a body, or taking the form of a body, formed from a blank, according to the manufacturing method according to the first aspect of the invention. According to an embodiment, the watch component may be an assembly of several parts. In particular, the watch component can be a watch bezel formed as a single part, or the watch component can be a watch bezel for example comprising a bezel ring (a base) and a bezel disk, attached or chased or set on the bezel.

According to an embodiment, the body comprises a base surface, at least one projecting or relief portion projecting from the base surface and comprising a top and at least one side arranged between the base surface and the top. The top preferably has a surface parallel to that of the base surface, but it can also have a surface which is not parallel to the base surface. The top and said at least one side of said projecting portion of said body are covered by a coating formed using the manufacturing method according to the first aspect of the invention, and the base surface of said body has been textured according to the manufacturing method according to the first aspect of the invention.

In other words the watch component comprises:
a body comprising:
   a base surface,
   at least one projecting or relief portion with respect to the base surface and comprising a top and at least one side arranged between the base surface and the top,
wherein the top and said at least one side are covered by a coating (at least one coating layer),
and wherein the base surface is textured,
   the base surface having been coated at the same time as the top and said at least one side,
   the coating of the base surface having been removed by a laser processing also used for (preferably simultaneously) texturing the base surface, and the laser processing using a laser source emitting ultrashort pulses (in the range of the nanosecond, of the picosecond or of the femtosecond).

According to the implementation above, a watch component is obtained with at least one coated projecting portion (top and sides included), in particular coated projecting parts (tops and sides included), and a textured base surface, with no intermediate transition area between these surfaces.

According to an embodiment, the watch component can form a watch decoration component such as a bezel, or a bezel disc, or a dial or a crown, or a pushbutton, or a clasp cover.

According to an embodiment, the at least one projecting portion comprises at least a top and a side arranged between the top of the at least one projecting portion and the base surface, and wherein said at least one side has a relief angle to a normal of the base surface preferably between 5° and 25°, in particular between 10° and 20°.

### DESCRIPTION OF THE FIGURES

Other features and advantages of this invention will become more clearly apparent on reading the following detailed description of an embodiment of the invention given by way of example without any limitation and illustrated by the appended drawings, wherein:

FIG. 1 shows a part, in perspective, of a timepiece comprising a watch component according to the invention, forming in this particular example a bezel disc of the timepiece;

FIG. 2 shows a perspective view of the bezel disc of the timepiece of FIG. 1;

FIG. 3a shows a first step of a simplified diagram of a method of manufacturing of the bezel disc of FIG. 2;

FIG. 3b shows a second step of a simplified diagram of a method of manufacturing of the bezel disc of FIG. 2;

FIG. 3c shows a third step of a simplified diagram of a method of manufacturing of the bezel disc of FIG. 2;

FIG. 4 shows a section of the bezel disc of FIG. 2 along the axis II-II of this figure, in the first step of the manufacturing method of FIG. 3a;

FIG. 5 shows the section of FIG. 4 in the second step of the manufacturing method of FIG. 3b;

FIG. 6 shows the section of FIG. 4 in a first variant of the third step of the manufacturing method of FIG. 3c;

FIG. 7 shows the section of FIG. 4 in a second variant of the third step of the manufacturing method of FIG. 3c;

FIG. 8 shows the section of FIG. 4 in a third variant of the third step of the manufacturing method of FIG. 3c.

### DETAILED DESCRIPTION OF EMBODIMENT(S)

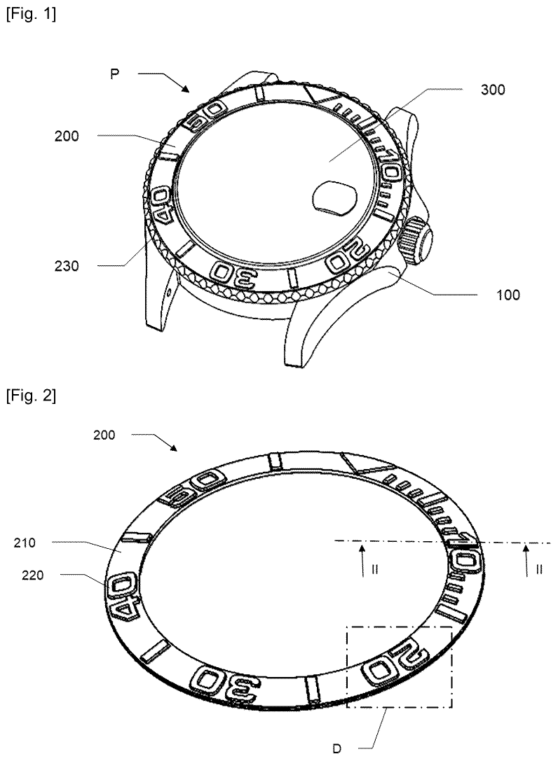

FIG. 1 shows a part in perspective of a timepiece P which generally comprises:
a case 100,
a watch component according to the invention, forming in this particular example a bezel comprising a bezel disc 200 secured to a bezel ring 230, toothed and mounted rotatably on the case 100,
a display interface 300 which may in particular comprise a dial, indexes, hands and figures to give, in particular, an indication of the hour or time to a user.

FIG. 2 shows a perspective view of the bezel disc 200 of the timepiece P of FIG. 1. The bezel disc 200 particularly comprises:
a base surface 210,
projecting portions 220 projecting from the base surface 210, here forming figures and indices. One could note on the example of FIG. 2 that the bezel is a revolution part and that the base surface 210, inclined with respect to the axis of revolution, is conical. Provision is made for the bezel disc 200 of FIG. 2 to be coupled to a bezel ring 230 comprising a lateral part, here toothed as shown in FIG. 1 to allow a user to rotate the bezel with respect to the case 100 of the timepiece P of FIG. 1. Of course, the bezel disc 200 and/or more specifically the bezel ring 230 may comprise on the inner face machined functional surfaces to allow mounting in a pivot linkage on the case 100 of the timepiece P of FIG. 1. Alternatively, the bezel can be attached to the case 100.

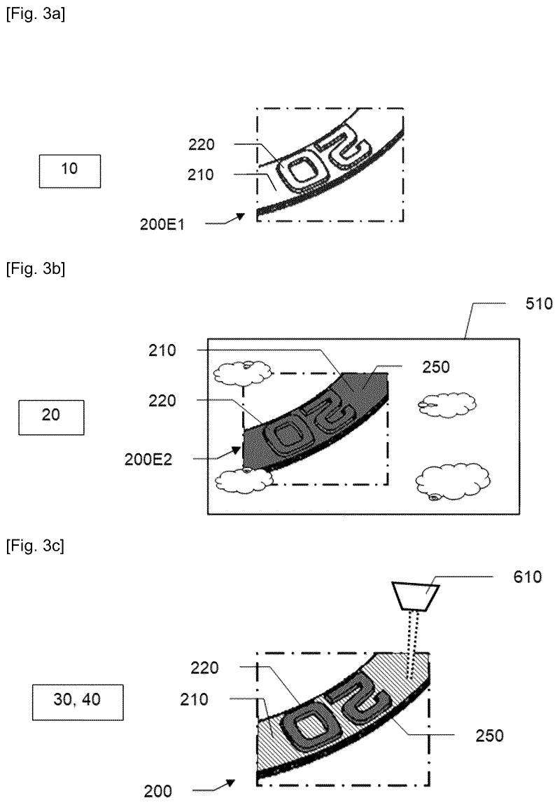

This disclosure has the aim of proposing an enhancement of the bezel disc 200 with patterns in projection or in positive relief on a base and with different colors and/or textures, but FIG. 1 and FIG. 2, for reasons of clarity, do not show these different colors and/or textures. For this purpose, one will keep to FIG. 3c (or else to FIGS. 6 to 8) showing different aspects between the surfaces of the manufactured part.

This disclosure therefore relates to a watch component, such as the bezel disc 200 of FIG. 2, or can specifically pertain to a bezel or to a dial, which include colored patterns in projection or in positive relief on a base, for example ceramic or textured metal.

To do this, with a view to specifically obtaining a bezel disc 200, this disclosure pertains to a method which in particular includes the successive steps shown very schematically in FIGS. 3a-3c and listed below:
(10—FIG. 3a): forming a blank 200E1, particularly by injection, including at least the base surface 210 and at least a projecting portion 220 projecting from the base surface 210,
(20—FIG. 3b): forming at least one coating layer 250 covering at least a part of the base surface 210 and/or at least a part of the projecting portion 220, to obtain a coated blank 200E2,
(30—FIG. 3c): removing by laser ablation at least a part of said at least one coating layer 250, and preferably simultaneously (40): texture by laser processing at least a part of the base surface 210 previously covered by said at least one coating layer 250, to obtain the bezel disc 200.

This above description of the manufacturing method lists the main steps of the method, and in detail, provision can be made for the following features.

A first step 10 therefore consists in obtaining a blank 200E1 with projecting portions 220.

According to a first embodiment and a first sub-step of the step 10 of forming a blank 200E1, the blanks 200E1 can be obtained by a molding method, of injection or pressing type.

The material of the component which is injected may be a metal, a composite, a cermet, or a technical ceramic. Advantageously, the technical ceramic may be mostly or mainly (in mass or in moles) composed of zirconium oxide, and/or aluminum oxide. Thus, the zirconium and/or aluminum oxide may be the predominant elements in the ceramic. Various elements can be added to this technical ceramic to improve its performance, such as Hf, Y, Al, Si, Mg, Fe, Ni, Cr, Zn, Co, Mn, Cu, Ti, Ta, W, Pt, as known to those skilled in the art. Yttria-stabilized zirconium (2Y—ZrO2 or 3Y—ZrO2), as is described in the patent application WO2022101450, can be used for the watch component blank. Alternatively, the technical ceramic used could for example be made of glass, sapphire, or mineral material.

In the case of a metal, the injection may comprise the injection of a metallic alloy in fusion or in the vitreous state (namely at an injection temperature lower than the fusion temperature and greater than the glass transition temperature) in the injection mold. After its cooling, it is possible to obtain, for example, a blank 200E1 of a watch component made of an amorphous material, such as a metallic glass. In particular, the material of the blank can be any amorphous alloy, the GFA (Glass Forming Ability) of which makes it possible to obtain an amorphous structure in the typical dimensions of watch components, particularly an amorphous metallic alloy comprising a metallic base formed of at least one metal from among the elements nickel (Ni), copper (Cu), palladium (Pd), platinum (Pt), iron (Fe), cobalt (Co), titanium (Ti), niobium (Nb), zirconium (Zr) and their alloys or blends.

In the case of a technical ceramic or a cermet, the blanks 200E1 are in particular obtained by an injection method including a step of sintering the green body obtained after injection. One may for example consider cermets comprising a ceramic phase of tungsten carbide, and/or titanium carbide, and/or zirconium carbide type and a metallic binder comprising one or more of the elements Ag, Pd, Co, Ni, Mo, Ru, Rh, Os, Ir, Pt, Au.

According to another embodiment, the blanks 200E1 may be obtained by stamping, nutation or beating type, or by pressing.

These stamping parts are preferably made of a metal or metal alloy.

According to yet another embodiment, the blanks 200E1 may be obtained by machining, in particular by laser machining or by mechanical machining of a ceramic or metallic element or of a cermet.

The view of FIG. 3a therefore shows a blank 200E1 formed using one of the techniques above.

Provision can be made for forming a part as a single part (the blank 200E1 is made as a single part), or provision can alternatively be made for a part which is composite and/or assembled with a bezel ring made of a single material, and the added-on bezel disc 200 made of a single material.

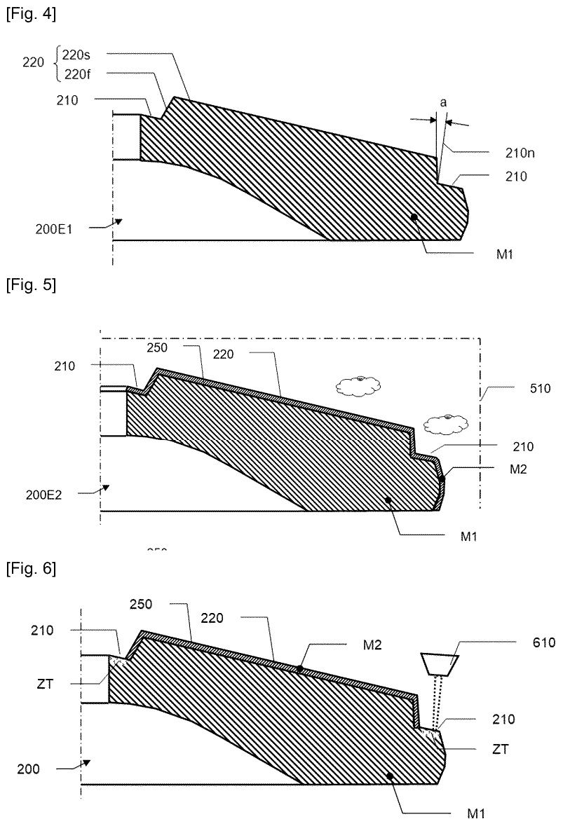

FIG. 4 shows a section of the bezel disc 200 of FIG. 2 along the axis II-II of this figure, after the first step. The step 200E1 comprises projecting portions 220 projecting from the base surface 210 and which comprise a top 220s and sides 220f, arranged between the top 220s and the base surface 210.

The projecting portions 220 extend along a normal 210n to the base surface 210 over a distance or over a height of less than 1 mm, preferably less than 0.5 mm, and very preferably less than 0.3 mm from the base surface 210. These patterns can extend over a height of at least 0.1 mm, or 0.15 mm, or 0.2 mm, or 0.25 mm, or 0.5 mm from the base surface 210 of the blank 200E1.

Advantageously, the sides 220f of the projecting portions 220 moreover form an angle different from 90° to the base surface. With reference to FIG. 4, the angle a between the side 220f and a normal 210n to the base surface 210 can be equal to 15°. More generally, this angle a is less than or equal to 30°, or less than or equal to 25°, or less than or equal to 20°, or less than or equal to 15°, or less than or equal to 10°, or less than or equal to 5°. Alternatively, this angle a can be equal to 0°. Still on FIG. 4, note the angle b between a normal to the base surface 210 and a normal to the lower surface of the part. In this non-limiting exemplary embodiment, the angle b is different from 0°, i.e. the base surface 210 is generally beveled.

A second sub-step of the step 10 of formation of a blank 200E1 may consist in machining, in particular grinding, by milling for example, the surfaces forming the inner and/or outer diameters, along with the surface forming the bottom of the blank 200E1 of the bezel disc 200.

It is naturally possible to defer and/or complete this step after any of the steps of the method. In particular, provision can for example be made for machining the toothed lateral part 230 at every ending of the manufacturing method.

A third sub-step of the step 10 of formation of a blank 200E1 may consist in making a finishing of the blank 200E1 obtained.

This can for example be a finishing step making it possible to obtain a modification of the surface condition of the at least one visible surface of the blank 200E1 by interposed media, preferably of all the surfaces of the blank 200E1. This step may comprise, for example, the mechanical stressing of an abrasive mixture by impact, for example by vibrational, oscillatory or rotary movement, for example in a vat (tribofinishing) of at least one blank 200E1 of the bezel disc 200, preferably a multitude of blanks 200E1. It also comprises, for example, without limitation, tumbling, and/or barreling, and/or sandblasting and/or shot-blasting and/or wet jetting of the at least one visible surface of the blank 200E1, in particular of all the surfaces of the blank 200E1.

Alternatively, this step may comprise a step of laser polishing, or electrochemical polishing for metallic parts.

One may then consider a lapping of the top 220s of the projecting portions 220 of the blank 200E1, in particular at their upper surface.

The manufacturing method can continue with the step 20 of formation of at least one coating layer 250 on a part of the blank 200E1, to obtain a coated blank 200E2. In detail, this step may consist in depositing at least one layer forming a coating 250 on the visible face of the blank 200E1, which comprises the projecting portions 220, as can be seen on FIG. 3b or on the section of FIG. 5. Preferably, the material of the deposited layer is a metal or a metallic alloy or a ceramic. The deposition can be of metallic or ceramic appearance. This step makes it possible to form at least one layer of a coating on the upper surface of the projecting portions 220, as well as on the sides 220f of said projecting portions 220, which can advantageously be favored by the fact that the sides form an angle greater than 0° to the normal 210n on the base surface 210 of the blank 200E1. This step also makes it possible to form the at least one layer on the base surface 210 from which the projecting portions 220 extend.

The deposition method can be done in an enclosed chamber 510, preferably carried out by Physical Vapor Deposition (PVD). Alternatively, the deposition can be carried out by Chemical Vapor Deposition (CVD) or Atom Layer Deposition (ALD).

Advantageously, such techniques well-known to those skilled in the art can be used, for example, to obtain nitrides (CrN, TiN, ZrN . . . ), carbonate composites (TiC, WC), or combinations (TiCN, AlTiCN).

Preferably, a layer of a metal carbide or of a metal nitride will be chosen for the present embodiment, such as for example:
Tungsten carbide, titanium carbide, zirconium carbide, tantalum carbide, niobium carbide, chromium carbide, hafnium carbide.
Titanium nitride, zirconium nitride, chromium nitride, tantalum nitride, niobium nitride, hafnium nitride, boron nitride.

A wide variety of proposals is possible. A great number of combinations can be considered, such as for example:
A combination of two nitrides and/or metallic alloy carbides, such as TiAlN/CrAlN;
A combination of nitride and carbide, such as HfTiCN, which may procure a bronze metallic brilliance.

Preferably, a layer of chromium nitride CrN may be chosen for this embodiment, due to its high hardness (one can for example obtain a hardness greater than 1000 HV, preferably greater than 1500 HV). More generally, one may prefer a hard ceramic-based layer to form the coating or to at least partially form the coating, if possible of metallic appearance.

Of course, one may consider the depositing of several superimposed layers to form the coating. For example, a layer of silicon nitride Si₃N₄ could be combined with a layer of titanium nitride in order to obtain a particular effect.

The second main step 20 can thus comprise a succession of sub-steps consisting in depositing superimposed layers comprising or consisting of different materials.

Other layers could moreover be considered. A layer comprising or consisting of carbon, commonly known by the name of DLC (Diamond-Like Carbon) could for example be deposited. Alternatively, a layer comprising or consisting of oxides could be deposited.

It is naturally possible to combine different layers in order to obtain a particular hardness and/or effect if these are technically compatible.

Thus, one may consider depositing at least one layer of a metallic oxide, particularly tantalum oxide such as tantalum oxide of Ta₂O₅ stoichiometry, or a titanium oxide, or a silicon oxide, or an aluminum oxide, or a metallic alloy oxide, or a metallic oxynitride or metallic alloy oxynitride.

FIG. 5 shows the section of FIG. 4, the part being placed in the enclosed chamber 510, to apply a layer of a coating 250 covering the entire base surface 210 and all the projecting portions 220, to obtain a coated blank 200E2. Schematically, the basic material of the blank 200E2 is represented as M1, and the material of the coating 250 or of the coating layer 250 is represented as M2, to clearly show that one obtains a coated blank 200E2 comprising at least two materials (the base material M1, and the material M2 of at least one coating layer).

Once the coating 250 is applied to the exposed surfaces (typically all the visible surfaces) of the blank 200E1, provision can be made for removing this coating over a part of these surfaces, to provide an additional visual effect with different colors, and/or also different textures.

For this purpose, a third main step 30 consists in removing by way of a laser source 610 the at least one layer disposed on one of the exposed surfaces, simultaneously with a fourth step 40 of texturing of this base surface 210.

Preferably, the coating is removed from all or part of the base surface 210 during this third step 30.

Alternatively or additionally, the coating is removed from all or part of the surfaces of the projecting portions 220.

This step 30 of removing the at least one deposited layer is preferably simultaneous with a step 40 of texturing of the processed surfaces.

The laser source 610 used is preferably a laser source 610 with ultrashort pulses, such as a laser with nanosecond, picosecond or femtosecond pulses.

The laser source 610 locally removes material over a thickness that can exceed the thickness of the at least one previously deposited layer. Note that the removal of material must not weaken the watch component. A maximum laser ablation thickness can be defined as a function of the material and/or the part geometry. Provision can also be made for making several passes.

The laser source 610 can also create aesthetically reliefs on the at least one decorative layer and/or on the bared surfaces of the substrate. In particular, the laser source 610 can create aesthetically reliefs on the surfaces of the substrate by uncoating a layer preliminary coated. One Examples of texturing of the at least one surface can be by forming a satin finishing, and/or a brushing, and/or a snailing, and/or a sunray brushing, and/or at least one “côthe de Genève”, and/or circular graining and/or spotting. FIG. 3c schematically represents a sunray brushing formed on the base surface 210.

According to a first embodiment illustrated on FIG. 6, the laser ablation is carried out on the base surface 210 and on the side of the coated blank 200E2, over a thickness at least equal to the thickness of the at least one deposited layer, and a simultaneous texturing of the base surface 210 thus revealed is made, such as to carry out, for example, a sunray brushing (on this figure, the textured areas are denoted ZT to clearly show their position). Here neither the projecting portions 220 (nor their tops 220s nor their sides 220s) are touched by the laser beam. The laser beam thus has the dual function of taking off the material layer M2 of the coating 250 and decorating the base surface 210 of the coated blank 200E2.

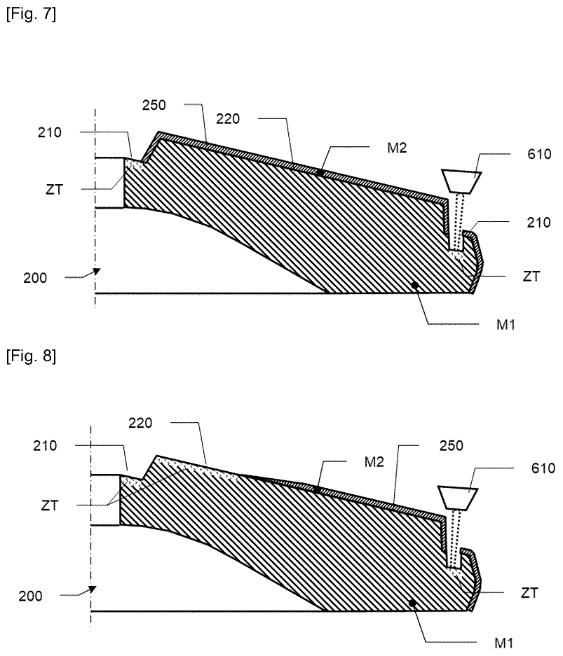

According to a second embodiment illustrated in particular in FIG. 7, the laser ablation can be carried out over a part of the base surface 210 (left part of FIG. 7), and provision can be made for machining and texturing with the laser source 610 a cavity or a slot in the material M1 of the coated blank 200E2, as shown in the right part of FIG. 7. On this figure, the textured areas are denoted ZT to clearly show their position.

According to a third embodiment illustrated in particular in FIG. 8, the laser ablation can be carried out locally on the blank, on the projecting portions 220 (and/or its sides and/or on the base), over a thickness which can be variable. A texturing of the bared surface can be done locally on the part with the same laser during the same operation.

An ablation of variable thickness as shown in FIG. 8 can have a very beneficial aesthetic effect. In the at least one deposited layer, this can for example introduce a color gradation. On the part as a whole, this can provide highlights and an impression of depth. In this figure, the textured areas are denoted ZT to clearly show their position.

### INDUSTRIAL APPLICATION

A method of fabrication and/or a watch component according to this invention, are able to be industrially applied.

It will be understood that various modifications and/or improvements obvious to those skilled in the art can be made to the different embodiments of the invention described in this description without departing from the scope of the invention.

1. A method of manufacturing of a watch component, comprising the steps consisting in:
forming a blank, particularly by injection, comprising at least one base surface and at least one projecting portion projecting from the base surface,
forming at least one coating layer covering at least a part of the base surface and/or covering at least a part of the at least one projecting portion,
removing by laser ablation at least a part of said at least one coating layer,
texturing by laser processing at least a part of the base surface previously covered by said at least one coating layer and/or at least a part of the at least one projecting portion previously covered by said at least one coating layer, and/or at least a part of the at least one coating layer.

2. The manufacturing method as claimed in claim 1, wherein the step of removal by laser ablation is carried out to:
locally remove a total thickness of the coating and optionally a thickness of the blank from the base surface, and/or
locally remove a thickness of the coating lower than the total thickness of the coating, and/or
locally remove a variable thickness of the coating strictly lower than the total thickness of the coating.

3. The manufacturing method as claimed in claim 1, said at least one projecting portion comprising at least one surface forming a top and at least one surface forming a side arranged between the top and the base surface,
wherein the step of formation said at least one coating layer is provided to form a coating covering at least a part of the base surface, at least a part of the surface forming the top of the at least one projecting portion and at least a part of the surface forming the side of the at least one projecting portion,
wherein the removal step is carried out to remove the coating covering the base surface, and wherein the texturing step is carried out to texture at least a part of the base surface.

4. The manufacturing method as claimed in claim 1, wherein the step of removal by laser ablation and the step of texturing by laser processing are at least partially simultaneous, and/or carried out with one and the same laser source.

5. The manufacturing method as claimed in claim 1, wherein the step of removal by laser ablation and the step of texturing by laser processing are carried out with an ultrashort pulsed laser source, and preferably with a pulsed laser source arranged to emit pulses in the range of the nanosecond, and more preferably in the range of the picosecond, and more preferably still in the range of the femtosecond.

6. The manufacturing method as claimed in claim 1, comprising a step of machining and/or grinding of the blank, executed after the step of formation of the blank and in particular between the step of formation of the blank and the step of formation of said at least one coating layer.

7. The manufacturing method as claimed in claim 1, comprising a step of finishing of the blank executed between the step of formation of the blank and the step of formation of said at least one coating layer.

8. The manufacturing method as claimed in claim 1, wherein the step of formation of said at least one coating layer comprises a step of Physical Vapor Deposition (PVD), and/or a step of Chemical Vapor Deposition (CVD), and/or a step of Atomic Layer Deposition (ALD).

9. The manufacturing method as claimed in claim 1, wherein the step of formation of said at least one coating layer comprises the formation of at least one layer of ceramic material and/or at least one layer of material comprising a metallic composite.

10. The manufacturing method as claimed in claim 9, wherein the step of formation of said at least one coating layer comprises the formation of at least one layer comprising at least:
a metal carbide, in particular tungsten carbide, and/or titanium carbide, and/or zirconium carbide, and/or tantalum carbide, and/or niobium carbide, and/or chromium carbide, and/or hafnium carbide, and/or
at least one metal nitride, in particular chromium nitride, and/or boron nitride, and/or zirconium nitride, and/or titanium nitride, and/or tantalum nitride, and/or niobium nitride, and/or hafnium nitride, and/or
a combination of different metal carbides as above and/or a combination of different metal nitrides as above, and/or a combination of a metal nitride as above and a metal carbide as above in an alloy.

11. The manufacturing method as claimed in claim 10, wherein the metal of the at least one coating layer is part of the group comprising tungsten (W), and/or titanium (Ti), and/or zirconium (Zr), and/or tantalum (Ta), and/or niobium (Nb), and/or chromium (Cr), and/or hafnium (Hf), or their alloys such as titanium-aluminum (TiAl), chromium-aluminum (CrAl), or hafnium-titanium (HfTi) alloys.

12. The manufacturing method as claimed in claim 1, wherein the texturing step is carried out to texture at least one coating layer and/or the base surface and/or the projecting portion forming a satin finishing, and/or a brushing, and/or a snailing, and/or a sunray brushing, and/or at least one côthe de Genève, and/or circular graining and/or spotting and/or any type of decoration, in particular any type of decoration with repeated patterns.

13. A watch component intended to be mounted in a timepiece, comprising a body or taking the form of a body formed from a blank, according to the manufacturing method of claim 1.

14. A watch component intended to be mounted in a timepiece, comprising a body or taking the form of a body formed from a blank according to the manufacturing method of claim 1, wherein the body comprises a base surface, at least one projecting portion projecting from to the base surface and comprising a top and at least one side arranged between the base surface and the top, wherein the top and said at least one side are covered by the at least one coating layer, and wherein the base surface is textured by the texturing by the laser processing.

15. The watch component as claimed in claim 13, forming a watch decoration component such as a bezel, or a bezel disc, or a dial or a crown, or a pushbutton, or a clasp cover.

16. The watch component as claimed in claim 13, wherein the at least one projecting portion comprises at least a top and a side arranged between the top of the projecting portion and the base surface, and wherein said at least one side has a relief angle to a normal of the base surface preferably between 5° and 25°, in particular between 10° and 20°.

17. The watch component as claimed in claim 13, wherein the blank comprises a ceramic material and/or a metallic material and/or a cermet.
